(19) United States
(12) Patent Application Publication
(10) Pub. No.: US 2005/0107559 A1
(43) Pub. Date: May 19, 2005

(54) Ethylene-C4-C20-alkene copolymers

(76) Inventors: Geoffrey W. Coates, Ithaca, NY (US); Masayuki Fujita, Chiba Pref. (JP)

Correspondence Address: BACON & THOMAS, PLLC, 625 SLATERS LANE, FOURTH FLOOR, ALEXANDRIA, VA, 22314, US

(21) Appl. No.: 10/983,680

(22) Filed: Nov. 9, 2004

Related U.S. Application Data
(60) Provisional application No. 60/519,626, filed on Nov. 14, 2003.

(51) Int. Cl. C08F 20/06

(52) U.S. Cl. 526/348.3

(57) ABSTRACT

Poly (ethylene-co-C₄-C₂₀-alkene) copolymers or segments with polydispersities less than 1.3 and/or predominantly enchainment in a cis-1,2 fashion and/or poly(ethylene-co-C₄-C₂₀ monocyclic alkene) copolymers or segments provide in some cases substitutes for ultra high molecular weight polyethylenes and in some cases substitutes for polypropylenes and in some cases utility as gas barrier coatings.

### CROSS-REFERENCE TO RELATED APPLICATIONS

This application claims the benefit of U.S. Provisional Patent Application No. 60/519,626, filed Nov. 14, 2003.

This invention was made at least in part with United States Government support under United States National Science Foundation Materials Research Science and Engineering Centers program DMR-0079992. The United States Government has certain rights in the invention.

### TECHNICAL FIELD

This invention relates to ethylene-C₄-C₂₀-alkene copolymers.

### BACKGROUND OF THE INVENTION

Ultra high molecular weight polyethylenes are used, for example, as wear-resistant layers on the bottom of skis and as hip replacement implants. This material has the disadvantage that it is almost intractable and is difficult to mold and needs to be machined or sintered.

Polypropylenes while useful for many applications are not useful for applications requiring high thermal stability, e.g. for producing molded auto engine parts.

Ethylene-cyclopentene copolymers are known. In almost all cases, the copolymers have contained cis-1,3-enchainment of cyclopentene units to the extent that the 1,3-enchainment prohibits crystallization and a high degree of tacticity. In the case where cis-1,2 insertion and tacticity may have been obtained, the copolymers have high polydispersities, e.g. greater than 2.0 and therefore lack homogeneity.

### SUMMARY OF THE INVENTION

It has been discovered herein that ethylene-C₄-C₂₀-alkene copolymers can be prepared with low polydispersities and/or predominantly cis-1,2-enchainment which in some cases are advantageous substitutes for ultra high molecular weight polyethylenes, in other cases are useful for gas barrier coatings and in still other cases are advantageous substitutes for polypropylenes and have higher thermal stability than polypropylenes.

In one embodiment herein, denoted the first embodiment, the invention is directed at copolymers of ethylene and C₄-C₂₀-alkene (where the alkene is an alpha-olefin or monocyclic olefin), containing from 0.1 to 50 mol percent of said alkene with the remainder being ethylene, with said alkene units being 50 to 100% isolated, i.e., not adjacent another said alkene unit, e.g., 70 to 100% isolated, the copolymers having a number average molecular weight ranging from 10,000 to 2,700,000 g/mol and having a polydispersity less than 1.3 when the alkene is a linear alkene, and having a polydispersity less than 2.0, preferably less than 1.6, very preferably, less than 1.3 when the alkene is a monocyclic alkene. The copolymers of the first embodiment are advantageous substitutes for ultra high molecular weight polyethylenes, for example, for coatings on the bottom of skis and for hip replacement implants and have the good wear resistance of ultra high molecular weight polyethylenes and are more easily formed.

In another embodiment, denoted the second embodiment, the invention is directed at copolymers of ethylene and linear or monocyclic C₄-C₂₀ alkene, containing from 0.1 to 5 mol percent of said alkene, with the remainder being ethylene, with the alkene units being 50 to 100% isolated, i.e., not adjacent another said alkene unit, e.g., 70 to 100% isolated, the copolymer having a number average molecular weight ranging from 10,000 to 2,700,000 g/mol and having a polydispersity less than 2.0, preferably less than 1.6, very preferably less than 1.3, when the copolymer is a copolymer of ethylene and monocyclic alkene, and having a polydispersity less than 2.0, preferably less than 1.6, very preferably less than 1.3, when the copolymer is a copolymer of ethylene and a linear alkene. The copolymers of this embodiment have the same utilities of those of the first embodiment.

In another embodiment, denoted the third embodiment, the invention is directed at copolymers of ethylene and cyclopentene containing from 10 to 50 mol percent cyclopentene which is more than 50% enchained in a cis-1,2 isotactic fashion, with the remainder of the copolymer being ethylene, which have a number average molecular weight ranging from 10,000 to 2,700,000 g/mol and a monomodal molecular weight distribution. The copolymers of the third embodiment are useful as substitutes for isotactic polypropylenes and have better thermal stability than isotactic polypropylenes.

In still another embodiment herein, denoted the fourth embodiment, the invention is directed at copolymers of ethylene and cyclopentene containing from 1 to 49 mol percent cyclopentene which is more than 50% enchained in a cis-1,2-non-isotactic fashion, which have a number average molecular weight ranging from 10,000 to 2,700,000 g/mol and a polydispersity less than 4. Copolymers of the fourth embodiment are useful as gas barrier coatings.

In yet another embodiment herein, denoted the fifth embodiment, the invention is directed to block copolymers containing at least one block (a) of poly (C₄-C₂₀-alkene-co-ethylene) having a number average molecular weight ranging from 5,000 to 500,000 g/mol, e.g., 5,000 to 200,000 g/mol, where the C₄-C₂₀-alkene is a linear or monocyclic olefin, and containing from 1 to 45% mol % said alkene content and from 99 to 55 mol % ethylene content, and at least one block (b) of poly (C₂-C₁₀ olefin) homopolymer and/or copolymer of two or more C₂-C₁₀ olefins where the block(s) (b) have a number average molecular weight ranging from 5,000 to 500,000 g/mol, e.g., 5,000 to 200,000 g/mol, and where block (a) and block(s) b are different in chemical constitution from one another. The block copolymers are useful as substitutes for polypropylenes.

In yet another embodiment herein, denoted the sixth embodiment, the invention is directed to a method of making the copolymer of the first embodiment, comprising reacting ethylene and a linear or monocyclic C₄-C₂₀ alkene in the presence of a catalyst that exhibits negligible chain transfer.

Number average molecular weights (Mₙ), weight average molecular weights (M_{w}) and polydispersities (M_{w}/Mₙ) herein are determined by high-temperature gel permeation chromatography (GPC) in 1,2,4-trichlorobenzene at 140 C versus polystyrene standards.

1,2-and 1,3-enchainments are shown below:

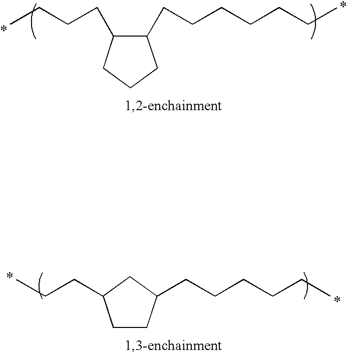

### DETAILED DESCRIPTION

We turn now to the first embodiment of the invention herein. Where the alkene is an alpha olefin, it can be, for example, 1-butene, 1-pentene, 1-hexene, 1-octene, 1-decene, 1-dodecene, 1-tetradecene, 1-hexadecene, 1-octadecene or 1-eicosene. Where the alkene is a monocyclic alkene, it can be, for example, cyclobutene, cyclopentene, cyclohexene, cyclooctene, cyclodecene or cyclododecene. In one case of the first embodiment, the alkene is cyclopentene and greater than 50%, e.g., 94 to 100%, of the cyclopentene is enchained in a cis-1,2 fashion.

The copolymers of the first embodiment include those of entries 1-9 of Table 1 of Fujita, M., et al, Macromolecules 35, 9640-9647 (2002) and can be made as described in and for said Table 1. In addition, copolymers of the first embodiment can be made by ring opening metathesis polymerization of bicyclo[3.2.0]hep-6-ene which can be made as described in Daubin, W. G., et al, Tetrahedron 12, 186-189 (1961) or Chapman, O. O., et al, J. Am. Chem. Soc. 84, 1220-1224 (1962), as described in Fujita, M., et al, Macromolecules 35, 9640-9647 (2002).

Copolymers of the first embodiment differ from those disclosed in Natta, G., et al, Makromol. Chem 54, 95-101 (1962) at least in the polydispersity limitation.

We turn now to the second embodiment of the invention herein.

The monocyclic alkenes can be, for example, any of those named in the description of the first embodiment. Copolymers of ethylene and cyclopentene of the second embodiment were made using the conditions of said Table 1, but with less cyclopentene. Samples made in this way and their properties are set forth in the table below where CP means cyclopentene, Tₘ means melting temperature (differential scanning calorimeter run at 10° C./min with the melting points reported being for the second heating run), Mₙ being number average molecular weight and PDI meaning polydispersity.

TABLE

| Sample | mol % CP | Tₘ(° C.) | Mₙ (g/mol) | PDI |
|---|---|---|---|---|
| 1 | 0.8 | 125.1 | 791 k | 1.75 |
| 2 | 1.7 | 123.9 | 418 k | 1.65 |
| 3 | 3.0 | 114.6 | 987 k | 1.32 |

We turn now to the third embodiment of the invention herein.

Copolymer of the third embodiment can be made as described in Fujita, M., et al, Macromolecules 35, 9640-9647 (2002) by ring opening metathesis polymerization of cicyclo[3.2.0]hept-6-ene using 2,6-diisopropylphenylimedoneophylidene [rac-BIPHEN] molybdenum VI, which is available from Strem. The catalyst complex in CH₂Cl₂ (1 mL) is added to monomer (M) solution and reaction is carried out using 8.5 micromol catalyst (C) and [M]/[C] ratio of 450 and 1 minute time. The resulting polymer (0.20-0.25 g) is dissolved in toluene with 4 to 5 g of p-toluene sulfonhydrazide and 0.05 g 2,6-di-tert-butyl-p-cresol and after refluxing for 9 hours, the reaction provided isotactic perfectly alternating copolymer of ethylene and cyclopentene having a number average molecular weight of 21 1,000 g/mol, a polydispersity of 1.55 and T_{g} of 17.0° C. and Tₘ of 181.6° C. as determined by ¹³C NMR. The copolymer contains no 1,3-units of cyclopentene, i.e., only 1,2-enchainment of cyclopentene. The copolymer has a monomodal molecular weight distribution (one peak on GPC) and distinguishes the copolymer of Natta, G., et al, Makromol. Chem. 54, 95-101 (1962) on this basis.

We turn now to the fourth embodiment of the invention herein.

The term “non-isotactic” means less than 90% m-dyads in a copolymer.

Copolymers meeting the fourth embodiment are set forth in Table 1 of Fujita, M., et al., Macromolecules 35, 9640-9647 (2002) and are made under the conditions described in and for said Table 1. To obtain copolymers meeting the cis-1,2 limitation, a catalyst providing living polymerization without beta hydride elimination, is used. A phenoxy-imine-based titanium catalyst used in conjunction with methylaluminoxane provides this result. A particular useful phenoxy-imine-based catalyst useful for this purpose and used in the syntheses of said Table 1 is prepared as described in Tian, J., et al., J. Am. Chem. Soc. 123, 5134-5135 (2001).

As indicated in Fujita, M., et al., Macromolecules 35, 9640-9647 (2002), T_{g} increases with increasing cyclopentene content. See FIG. 8 of Fujita, M., et al., Macromolecules 35, 9640-9647 (2002).

As indicated in Table 1 of Fujita, M., et al., Macromolecules 35, 9640-9647 (2002), there was no 1,3-enchainment at processing temperatures less than 40° C., e.g. at 25° C. or 0° C.

The copolymers of the fourth embodiment distinguish that of Natta, G., et al, Makromol. Chem. 54, 95-101 (1962) on the basis that Natta et al does not prepare non-isotactic copolymer.

We turn now to the fifth embodiment of the invention herein, i.e. the embodiment directed to block copolymers of polyethylene and poly (C₄-C₂₀-alkene-co-ethylene). In one case, the alkene is cyclopentene and greater than 50%, e.g., 94-100%, of the cyclopentene is enchained in cis-1,2 fashion. These are readily made using phenoxy-imine-based titanium catalyst, e.g. catalyst 3 depicted in FIG. 5 of Fujita, M., et al., Macromolecules 35, 9640-9647 (2002) prepared as described in Tian, J., et al, J. Am. Chem. Soc. 123, 5134-5135 (2001) used in conjunction with methylaluminoxane used in the presence of ethylene, e.g. at 40 psi, and after allowing ethylene polymerization to occur, e.g. for 2 minutes, to provide block of polyethylene, then reducing ethylene pressure, e.g. to 2 psi, and adding C₄-C₂₀-alkene, e.g., cyclopentene, to the reactor and polymerizing to provide block of poly (C₄-C₂₀-alkene-co-ethylene), and if desired then adding another block of polyethylene e.g. by increasing the ethylene pressure, and if desired then adding more blocks in like manner. Working examples are set forth in Tables 2 and 3 of Fujita, M., et al., Macromolecules 35, 9640-9647 (2002) and the description thereof in Fujita et al.

We turn now to the sixth embodiment of the invention herein. A suitable catalyst is the phenoxy-imine-based titanium catalyst described in conjunction with the fourth embodiment herein.

The invention is supported by experiments and results and conclusions from those that are set forth in Fujita, M. and Coates, G. W., Macromolecules 35, 9640-9647 (2002).

Variations

The foregoing description of the invention has been presented describing certain operable and preferred embodiments. It is not intended that the invention should be so limited since variations and modifications thereof will be obvious to those skilled in the art, all of which are within the spirit and scope of the invention.

1. Copolymer of ethylene and linear or monocyclic C₄-C₂₀-alkene, containing from 0.1 to 50 mol percent of said alkene with the remainder being ethylene with the alkene units being 50 to 100% isolated, the copolymer having a number average molecular weight ranging from 10,000 to 2,700,000 g/mol and having a polydispersity less than 1.3 when the alkene is a linear alkene and having a polydispersity less than 2.0 when the alkene is a monocyclic alkene.

2. A copolymer as defined in claim 1 where the alkene is a monocyclic C₄-C₂₀ alkene and the polydispersity is less than 1.3.

3. The copolymer of claim 2 where the alkene is cyclopentene and greater than 50% of the cyclopentene is enchained in a cis-1,2 fashion.

4. A copolymer as defined in claim 3 which has a polydispersity less than 1.2.

5. A copolymer as defined in claim 1 which has a polydispersity less than 1.2.

6. Copolymer of ethylene and linear or monocyclic C₄-C₂₀ alkene, containing from 0.1 to 5 mol percent of said alkene with the remainder being ethylene, with alkene units being 50 to 100% isolated, the copolymer having a number average molecular weight ranging from 10,000 to 2,700,000 g/mol and having a polydispersity less than 2.0 when the copolymer is a copolymer of ethylene and monocyclic alkene and having a polydispersity less than 2.0 when copolymer is a copolymer of ethylene and a linear alkene.

7. Copolymer as claimed in claim 6 where the polydispersity is less than 1.6.

8. Copolymer as claimed in claim 6 where the polydispersity is less than 1.3.

9. Copolymer as defined in claim 8 which has a number average molecular weight ranging from 500,000 to 2,700,000 g/mol.

10. Copolymer as defined in claim 8 which has a weight average molecular weight greater than 1,000,000 g/mol.

11. Copolymer of ethylene and cyclopentene containing from 10 to 50 mol percent cyclopentene which is more than 50% enchained in a cis-1,2 isotactic fashion, which has a number average molecular weight ranging from 10,000 to 2,700,000 and a monomodal molecular weight distribution.

12. Copolymer of ethylene and cyclopentene containing from 1 to 49 mol percent cyclopentene which is more than 50% enchained in a cis-1,2-non-isotactic fashion, which has a number average molecular weight ranging from 10,000 to 2,700,000 and a polydispersity less than 4 .

13. Block copolymer containing at least one block (a) of poly (linear or monocyclic C₄-C₂₀-alkene-co-ethylene) having a number average molecular weight ranging from 5,000 to 500,000 g/mol and containing 1 to 45 mol % said alkene and 99 to 55 mol % ethylene and at least one block (b) of poly (C₂-C₁₀olefin) homopolymer and/or copolymer of two or more C₂-C₁₀ olefins where the block(s) (b) have a number average molecular weight ranging from 5,000 to 500,000 g/mol and where block (a) and block(s) (b) are different in chemical constitution from one another.

14. The copolymer of claim 14 where the alkene is cyclopentene, and greater than 50% of the cyclopentene is enchained in cis-1,2 fashion.

15. A method for making copolymer of claim 1, comprising reacting ethylene and a linear or monocyclic C₄-C₂₀ alkene in the presence of a catalyst that exhibits negligible chain transfer.
